(19) United States
(12) Patent Application Publication
(10) Pub. No.: US 2022/0027006 A1
(43) Pub. Date: Jan. 27, 2022

(54) DISPLAY SYSTEM, CONTROL DEVICE, AND CONTROL METHOD

(71) Applicant: Panasonic Intellectual Property Management Co., Ltd., Osaka (JP)

(72) Inventors: Atsushi HIRAI, Tokyo (JP); Yuji HASHIMOTO, Kanagawa (JP)

(73) Assignee: Panasonic Intellectual Property Management Co., Ltd., Osaka (JP)

(21) Appl. No.: 17/497,533

(22) Filed: Oct. 8, 2021

Related U.S. Application Data
(63) Continuation of application No. PCT/JP2020/015646, filed on Apr. 7, 2020.

(30) Foreign Application Priority Data
Apr. 10, 2019 (JP) 2019-074904

(51) Int. Cl. G06F 3/041; G06F 3/044

(52) U.S. Cl. CPC G06F 3/0412; G06F 3/044; G06F 3/04182; G06F 3/04166

(57) ABSTRACT

A display device includes multiple common electrodes. A drive circuit supplies a reference voltage for image display during a display period, for which the display device displays an image, and supplies a touch drive signal during a touch detection period, to each of the multiple common electrodes. A touch detection circuit performs detection of a touch by an object on the display device, during a touch detection period. A selector selects, as an operation mode of the display system, a first mode or a second mode. The first mode is an operation mode in which the display period and the touch detection period are alternately arranged within each of multiple successive frame periods of the display device. The second mode is an operation mode in which, during at least one frame period, the display device displays an image while the touch detection circuit stops touch detection.

### BACKGROUND

### 1. Field

The present disclosure relates to a display system provided with a touch detection function, a control device, and a control method.

### 2. Description of the Related Art

An in-cell display device, in which a touch sensor for detecting a user's touch position is built into a display panel, is known (see Patent Literature 1, for example). In such a display device, a common electrode used to supply a common voltage to each pixel of a liquid crystal display panel is divided into multiple common electrodes, which are also used as touch sensor electrodes. During an image display period, a common voltage is supplied to each of the multiple common electrodes, and, during a touch detection period, a touch drive signal for touch detection is supplied to each of the multiple common electrodes.

Patent Literature 1: WO 2018/123813

### SUMMARY

For in-cell display devices, further improvement has been required.

To solve the problem above, a display system according to one aspect of the present disclosure includes: a display device including multiple gate lines, multiple source lines, multiple pixel electrodes provided respectively in regions defined by the multiple gate lines and the multiple source lines, and multiple common electrodes provided to face the multiple pixel electrodes and used for both image display and touch detection; a drive circuit that supplies a reference voltage for image display during a display period, for which the display device displays an image, and supplies a touch drive signal during a touch detection period, to each of the multiple common electrodes; a touch detection circuit that performs detection of a touch by an object on the display device, based on a touch detection signal received from each of the multiple common electrodes during the touch detection period; and a selector that selects, as an operation mode of the display system, a first mode or a second mode. The first mode is an operation mode in which the display period and the touch detection period are alternately arranged within each of multiple successive frame periods of the display device. The second mode is an operation mode in which, during at least one frame period, the display device displays an image while the touch detection circuit stops touch detection.

Another aspect of the present disclosure is a control device. The control device is provided in a display system that includes: a display device including multiple gate lines, multiple source lines, multiple pixel electrodes provided respectively in regions defined by the multiple gate lines and the multiple source lines, and multiple common electrodes provided to face the multiple pixel electrodes and used for both image display and touch detection; a drive circuit that supplies a reference voltage for image display during a display period, for which the display device displays an image, and supplies a touch drive signal during a touch detection period, to each of the multiple common electrodes; and a touch detection circuit that performs detection of a touch by an object on the display device, based on a touch detection signal received from each of the multiple common electrodes during the touch detection period. The control device includes a selector that selects, as an operation mode of the display system, a first mode or a second mode. The first mode is an operation mode in which the display period and the touch detection period are alternately arranged within each of multiple successive frame periods of the display device. The second mode is an operation mode in which, during at least one frame period, the display device displays an image while the touch detection circuit stops touch detection.

Yet another aspect of the present disclosure is a control method. The control method is used in a display system that includes: a display device including multiple gate lines, multiple source lines, multiple pixel electrodes provided respectively in regions defined by the multiple gate lines and the multiple source lines, and multiple common electrodes provided to face the multiple pixel electrodes and used for both image display and touch detection; a drive circuit that supplies a reference voltage for image display during a display period, for which the display device displays an image, and supplies a touch drive signal during a touch detection period, to each of the multiple common electrodes; and a touch detection circuit that performs detection of a touch by an object on the display device, based on a touch detection signal received from each of the multiple common electrodes during the touch detection period. The control method includes selecting, as an operation mode of the display system, a first mode or a second mode. The first mode is an operation mode in which the display period and the touch detection period are alternately arranged within each of multiple successive frame periods of the display device. The second mode is an operation mode in which, during at least one frame period, the display device displays an image while the touch detection circuit stops touch detection.

### BRIEF DESCRIPTION OF DRAWINGS

Embodiments will now be described, by way of example only, with reference to the accompanying drawings which are meant to be exemplary, not limiting, and wherein like elements are numbered alike in several Figures, in which:

FIG. 1 is a block diagram of a display system according to a first embodiment;

FIG. 2 is a diagram that schematically shows a circuit configuration of a display device shown in FIG. 1;

FIG. 3 is a top view that shows arrangement of common electrodes shown in FIG. 2;

FIG. 4 is a longitudinal sectional view of the display device shown in FIG. 1;

FIG. 5A is a diagram used to describe the operation of the display device shown in FIG. 1 during a touch detection period in a first mode, and FIG. 5B is a diagram that shows timings and a waveform of a common electrode signal within a frame period in the first mode of the display device shown in FIG. 1;

FIG. 6A is a diagram used to describe the operation of the display device shown in FIG. 1 in a second mode, and FIG. 6B is a diagram that shows timings and a waveform of a common electrode signal within a frame period in the second mode of the display device shown in FIG. 1;

FIG. 7 is a flowchart that shows mode selection processing performed in the display system shown in FIG. 1;

FIG. 8 is a block diagram of a host according to a second embodiment;

FIG. 9 is a flowchart that shows mode selection processing performed in the display system according to the second embodiment;

FIG. 10 is a diagram that shows a waveform of a common electrode signal within a frame period in the second mode according to a third embodiment;

FIG. 11 is a flowchart that shows mode selection processing performed in the display system according to the third embodiment;

FIG. 12 is a diagram that shows timings and a waveform of a common electrode signal within a frame period in the second mode according to a fourth embodiment;

FIG. 13 is a flowchart that shows mode selection processing performed in the display system according to the fourth embodiment;

FIG. 14 is a diagram that shows timings and a waveform of a common electrode signal within a frame period in the second mode according to a fifth embodiment;

FIG. 15 is a flowchart that shows mode selection processing performed in the display system according to the fifth embodiment; and

FIG. 16A is a diagram that illustrates multiple frame periods in the second mode according to a modification, FIG. 16B is a diagram that shows a waveform of a common electrode signal within a frame period Fa1 in the second mode according to the modification, and FIG. 16C is a diagram that shows a waveform of a common electrode signal within a frame period Fa2 in the second mode according to the modification.

### DETAILED DESCRIPTION

The invention will now be described by reference to the preferred embodiments. This does not intend to limit the scope of the present invention, but to exemplify the invention.

### Base Findings of Present Disclosure

Before specific description of embodiments is given, the base findings will be described. In an in-cell touch display, electrodes are not provided on the side closer to the viewer than the common electrodes. Accordingly, in an in-cell touch display, exogenous noise caused by wireless signals or the like around the touch display is more likely to reach the common electrodes, compared to an out-cell display device, in which touch sensor electrodes are arranged on the side closer to the viewer than the common electrodes. Therefore, the inventors have found a problem that exogenous noise may be transmitted from the common electrodes to a drive circuit for image display, for example, and such transmitted noise may affect the image display. The exogenous noise includes intense electric field noise emitted from radio towers and base stations, and noise caused by wireless signals for cellular phones, GPS, and Bluetooth (registered trademark), for example. The amount of noise that reaches the common electrodes can be reduced by providing a transparent electrode for shielding on the side closer to the viewer than the common electrodes; however, accuracy and sensitivity of touch position detection may be degraded thereby. To solve the problem, a display system according to the present disclosure is configured as described below.

Like reference characters denote like or corresponding constituting elements, members, and processes in each drawing, and repetitive description will be omitted as appropriate. Also, the dimensions of a member may be appropriately enlarged or reduced in each drawing in order to facilitate understanding.

### First Embodiment

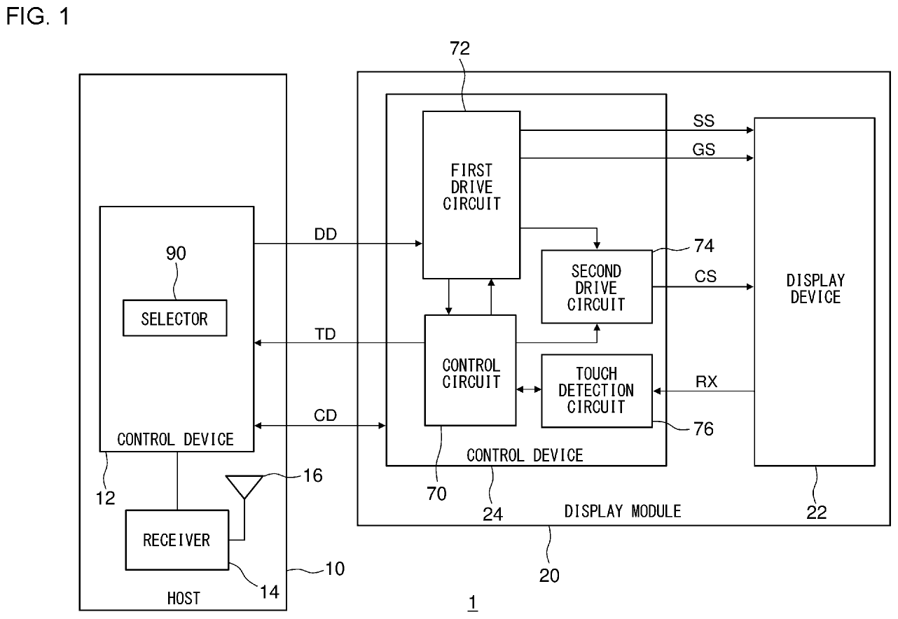

FIG. 1 is a block diagram of a display system 1 according to a first embodiment. Although an example will be described in which the display system 1 is a vehicle-mounted display system 1 mounted on a vehicle, such as an automobile, the application is not particularly limited. The display system 1 may also be used for a mobile device.

The display system 1 includes a host 10 and a display module 20. The host 10 performs various functions, such as radio, car navigation, and Bluetooth communication, and controls the display module 20. The host 10 includes a control device 12, a receiver 14, and an antenna 16.

The control device 12 may be a CPU, for example, and also called a host CPU. The control device 12 includes a selector 90 that selects an operation mode of the display system 1. The selector 90 selects a first mode in which image display and touch detection is performed, or a second mode in which image display is performed but touch detection is stopped.

The selector 90 selects the first mode at a time other than when image display needs to be preferentially performed. The selector 90 selects the second mode when image display needs to be preferentially performed. The second mode may also be referred to as a display priority mode. For example, when a camera display function for displaying an image captured by an imaging device mounted on the rear part of a vehicle is performed, or when a user has performed an operation for specifying the second mode, the selector 90 judges that image display should be preferentially performed and selects the second mode. The first mode and the second mode will be detailed later.

The control device 12 supplies, to the display module 20, image data DD and control data CD including information regarding the operation mode and controls the display module 20 based on such data. The control device 12 also controls the receiver 14.

The receiver 14 receives wireless signals via the antenna 16. The receiver 14 has at least one of the radio receiving function, GPS receiving function, or Bluetooth receiving function, for example.

The display module 20 includes a display device 22 and a control device 24. The display device 22 may be used as a center display on which a car navigation screen or the like is displayed within a vehicle cabin, for example.

The display device 22 is an in-cell liquid crystal display device of an in plane switching (IPS) type and configured as a touch display on which a touch position can be detected. The configuration of the display device 22 may be a well-known configuration as described below, for example.

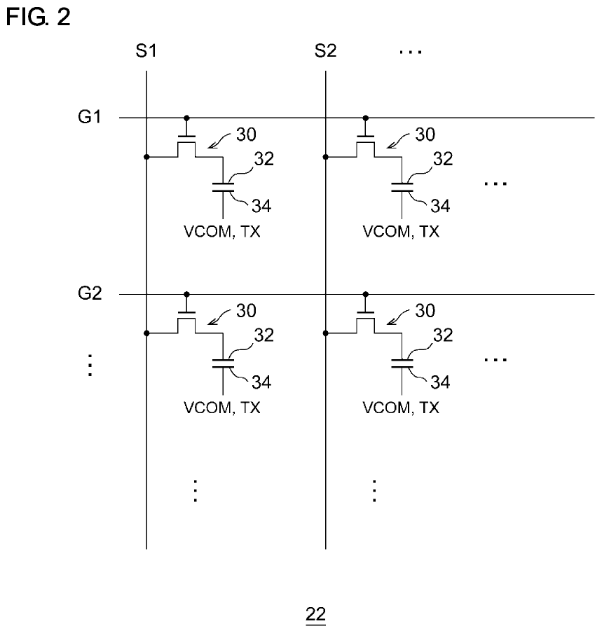

FIG. 2 schematically shows a circuit configuration of the display device 22 shown in FIG. 1. FIG. 2 also shows schematic arrangement of constituting elements. The display device 22 includes multiple gate lines G1, G2, and so on extending in a row direction, multiple source lines S1, S2, and so on extending in a column direction, multiple pixel switching elements 30, multiple pixel electrodes 32, and multiple common electrodes 34. Each pixel switching element 30 is a thin-film transistor provided near an intersection of a gate line and a source line such as to correspond to a pixel. In each pixel switching element 30, the gate is connected with a gate line, the source is connected with a source line, and the drain is connected with a pixel electrode 32. For one common electrode 34, multiple pixel switching elements 30 and multiple pixel electrodes 32 are arranged. The liquid crystal layer is controlled by means of electric fields between pixel electrodes 32 and common electrodes 34. The common electrodes 34 are used for both image display and touch detection. Accordingly, the number of electrode layers can be reduced, so that the display device 22 can be made thinner. The common electrodes 34 may also be referred to as sensor electrodes.

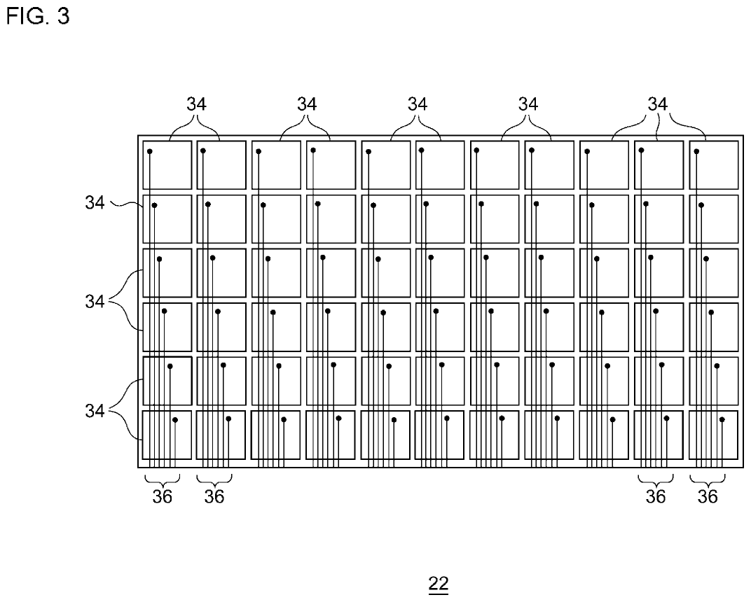

FIG. 3 is a top view that shows arrangement of common electrodes 34 shown in FIG. 2. The multiple common electrodes 34 are arranged in a matrix. Each common electrode 34 is connected to the control device 24 with a signal line 36.

The display device 22 detects a touch position based on the self-capacitance method. When a finger is brought closer to the display surface of the display device 22, capacitance is formed between a common electrode 34 and the finger. The formation of capacitance increases parasitic capacitance in the common electrode 34, so that the current flowing when a touch drive signal is supplied to the common electrode 34 is increased. Based on the current variation, the touch position is detected.

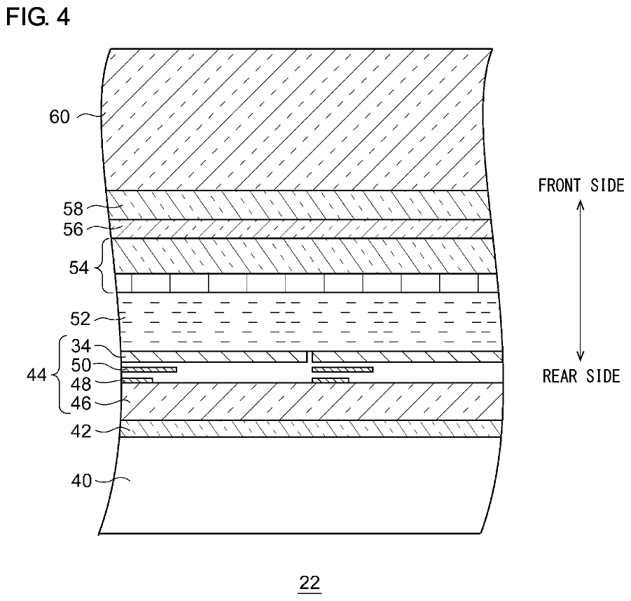

FIG. 4 is a longitudinal sectional view of the display device 22 shown in FIG. 1. The display device 22 includes a backlight unit 40, a lower polarizer 42, a thin-film transistor substrate (hereinafter, referred to as a TFT substrate) 44, a liquid crystal layer 52, a color filter substrate 54, an upper polarizer 56, a bonding layer 58, and a protection layer 60, which are laminated and disposed in this order along a depth direction.

In the following, with regard to the depth directions of the display device 22, the side on which the protection layer 60 is positioned with respect to the TFT substrate 44 is defined as the front side, and the opposite side is defined as the rear side.

Using the light emitted from the backlight unit 40, the display device 22 emits image light toward the front side, or the viewer side.

The TFT substrate 44 includes a glass substrate 46 and also includes multiple gate electrodes 48, multiple source electrodes 50, and multiple common electrodes 34, which are arranged on the front side of the glass substrate 46. The TFT substrate 44 also includes the multiple gate lines G1, G2, and so on, the multiple source lines S1, S2, and so on, the multiple pixel electrodes 32, and the multiple pixel switching elements 30 shown in FIG. 2, though illustration thereof is omitted. The liquid crystal layer 52 disposed on the front side of the TFT substrate 44 is controlled by means of lateral electric fields that occur between pixel electrodes 32 and common electrodes 34.

The bonding layer 58 has translucency and bonds the upper polarizer 56 and the protection layer 60. The bonding layer 58 may be formed by curing a transparent resin in a liquid state, such as optically clear resin (OCR), or curing a transparent adhesive sheet, such as optically clear adhesive (OCA), for example.

The protection layer 60 is a layer that has translucency and protects the display device 22, and the protection layer 60 is constituted by a glass substrate or a plastic substrate, for example. The protection layer 60 is also called a cover lens or the like.

In the display device 22, electrodes are not provided on the front side of the common electrodes 34. Accordingly, as described previously, exogenous noise is more likely to reach the common electrodes 34 in the display device 22, compared to the configuration in which electrodes are arranged on the front side of the common electrodes 34.

The description now returns to FIG. 1. The control device 24 may be configured as an IC, for example, and controls the display device 22 based on the control data CD and the image data DD from the host 10. The control device 24 includes a control circuit 70, a first drive circuit 72, a second drive circuit 74, and a touch detection circuit 76.

The control circuit 70 may be configured as a microcomputer, for example, and controls signal generation timings of the first drive circuit 72 and the second drive circuit 74, touch detection timings of the touch detection circuit 76, and the like.

In the first mode, the control circuit 70 controls the first drive circuit 72, the second drive circuit 74, and the touch detection circuit 76 such that, during a frame period (one frame period), one frame of a display image is rendered on the display device 22 and touch detection for one screen is performed at least once. The frame period may also be referred to as a vertical synchronization period. The frame period will be detailed later.

In the second mode, the control circuit 70 controls the first drive circuit 72, the second drive circuit 74, and the touch detection circuit 76 such that, during a frame period, one frame of a display image is rendered on the display device 22 and touch detection is stopped.

The operation of the first drive circuit 72 is identical in the first mode and the second mode. The first drive circuit 72 generates a reference clock signal under the control of the control circuit 70. The first drive circuit 72 also generates, under the control of the control circuit 70, a source signal SS in synchronization with the generated reference clock signal, based on the image data DD from the host 10. The first drive circuit 72 also generates, under the control of the control circuit 70, a gate signal GS in synchronization with the generated reference clock signal.

The first drive circuit 72 supplies the source signal SS serially to multiple source lines in the display device 22 and also supplies the gate signal GS serially to multiple gate lines in the display device 22.

The first drive circuit 72 supplies the reference clock signal to the second drive circuit 74. In the first mode, the second drive circuit 74 generates a reference voltage VCOM, which is a predetermined fixed voltage, and a touch drive signal TX in synchronization with the reference clock signal, under the control of the control circuit 70. The touch drive signal TX may be a square wave signal or may be a sine wave signal. In the first mode, through the signal lines 36 shown in FIG. 3, the second drive circuit 74 supplies the reference voltage VCOM or the touch drive signal TX as a common electrode signal CS to each of the multiple common electrodes 34 of the entire display device 22.

In the second mode, the second drive circuit 74 generates the reference voltage VCOM under the control of the control circuit 70 and supplies the reference voltage VCOM as the common electrode signal CS to each of the multiple common electrodes 34 through the signal lines 36.

The touch detection circuit 76 detects a touch by an object on the display device 22 in the first mode. Under the control of the control circuit 70, the touch detection circuit 76 performs detection of a touch by an object on a position corresponding to a common electrode 34, based on a touch detection signal RX received from the common electrode 34 when the touch drive signal TX is supplied to each common electrode 34. The touch detection circuit 76 outputs information regarding the position of a touch thus detected to the control circuit 70. The touch detection circuit 76 stops detection of a touch by an object on the display device 22 in the second mode.

Based on the information regarding the position of a touch from the touch detection circuit 76, the control circuit 70 derives coordinate data TD of the touch position and outputs the coordinate data TD to the control device 12 in the host 10. The control device 12 performs various processes based on the coordinate data TD.

The configurations of the control device 12 and the control circuit 70 can be implemented by cooperation between hardware resources and software resources or only by hardware resources. As the hardware resources, analog devices, microcomputers, DSPs, ROMs, RAMs, FPGAs, or other LSIs can be employed. As the software resources, programs, such as firmware, can be employed.

In the following, the first mode and the second mode will be detailed in turn.

### First Mode

In the first mode, the control circuit 70 alternately repeats partial image display on one of multiple display regions within the screen and partial touch detection on one of multiple touch detection regions within the screen, so as to control the image display and the touch detection in a time division manner.

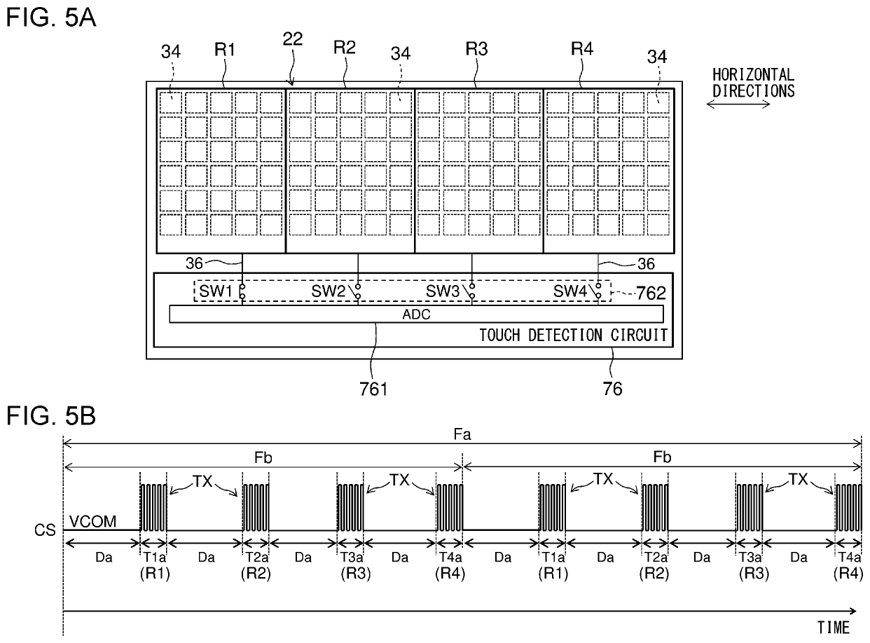

FIG. 5A is a diagram used to describe the operation of the display device 22 shown in FIG. 1 during a touch detection period in the first mode. The display device 22 includes touch detection regions R1, R2, R3, and R4, which are configured by dividing the multiple common electrodes 34 within the screen into multiple groups.

The touch detection regions R1, R2, R3, and R4 are horizontally arranged in this order from the left to the right when viewed from the viewer. Among the multiple common electrodes 34 of the entire display device 22, multiple common electrodes 34 are arranged in each of the touch detection regions R1 through R4. The number of common electrodes 34 arranged in each touch detection region shown in FIG. 5A is set as an example. Also, the number of touch detection regions in the display device 22 is not limited to “four”.

The touch detection circuit 76 includes an A/D converter 761 and a switch circuit 762. The switch circuit 762 is connected between the multiple common electrodes 34 and the A/D converter 761. The switch circuit 762 includes switches SW1, SW2, SW3, and SW4 and is configured as a multiplexer. Each switch includes multiple pairs of an input terminal and an output terminal, though illustration thereof is omitted. For simplified drawing, the connections between the common electrodes 34 and the signal lines 36 are omitted in FIG. 5A.

The multiple input terminals of the switch SW1 are respectively connected to the multiple common electrodes 34 included in the touch detection region R1 on a one-to-one basis, with the signal lines 36. The multiple input terminals of the switch SW2 are respectively connected to the multiple common electrodes 34 included in the touch detection region R2 on a one-to-one basis, with the signal lines 36. The multiple input terminals of the switch SW3 are respectively connected to the multiple common electrodes 34 included in the touch detection region R3 on a one-to-one basis, with the signal lines 36. The multiple input terminals of the switch SW4 are respectively connected to the multiple common electrodes 34 included in the touch detection region R4 on a one-to-one basis, with the signal lines 36.

The output terminals of the switches SW1 through SW4 are connected to multiple input ports of the A/D converter 761. Since the number of input ports of the A/D converter 761 is lower than the number of common electrodes 34 within the screen, the common electrodes 34 connected to the input ports of the A/D converter 761 are switched by means of the switches. The number of input ports of the A/D converter 761 is equal to the number of input signals that can be simultaneously processed at the A/D converter 761 and may also be referred to as the number of input channels.

FIG. 5B shows timings and a waveform of the common electrode signal CS within a frame period Fa in the first mode of the display device 22 shown in FIG. 1. In the example shown in FIG. 5B, within a frame period Fa, one image is displayed and touch detection for one screen is performed twice. In the present embodiment, the display device 22 is assumed to be a display device driven at 60 Hz to display an image, so that a frame period Fa is set to about 16.7 (=1/60) ms. Since the touch detection for one screen is performed twice within a frame period Fa, the touch detection is performed with a period of about 8.3 (=1/120) ms.

A frame period Fa is divided into two sub-frame periods Fb. Each sub-frame period Fb includes four display periods Da and four touch detection periods T1a, T2a, T3a, and T4a. The display periods Da and the touch detection periods are alternately arranged. In each sub-frame period Fb, the display period Da, touch detection period T1a, display period Da, touch detection period T2a, display period Da, touch detection period T3a, display period Da, and touch detection period T4a are arranged in this order. The number of display periods Da and the number of touch detection periods in a frame period Fa are not limited to “eight”.

The display device 22 displays one-eighth of a frame for each display period Da. Accordingly, one frame is displayed in the eight display periods Da within a frame period Fa. More specifically, during a display period Da, the first drive circuit 72 supplies the source signal SS to the multiple source lines and also supplies the gate signal GS to corresponding gate lines, and the second drive circuit 74 supplies the reference voltage VCOM to the multiple common electrodes 34. The second drive circuit 74 stops supply of the touch drive signal TX during the display periods Da.

During each touch detection period, the second drive circuit 74 supplies the touch drive signal TX to the multiple common electrodes 34 in the touch detection regions R1 through R4. The second drive circuit 74 stops supply of the reference voltage VCOM during each touch detection period.

The control circuit 70 makes a different one of the switches SW1, SW2, SW3, and SW4 conductive for each touch detection period. The touch detection signals RX input to the switch thus made conductive are output to the A/D converter 761. Accordingly, the switch circuit 762 outputs, to the A/D converter 761, the touch detection signals RX supplied from common electrodes 34 selected from among the multiple common electrodes 34. The A/D converter 761 converts the analog touch detection signals RX input via the switch into digital touch detection signals. The A/D converter 761 corresponds to a processing circuit that processes the touch detection signals RX. Based on the digital touch detection signals as output signals from the A/D converter 761, the touch detection circuit 76 performs touch detection.

During the touch detection period T1a, the touch detection circuit 76 performs detection of a touch by an object on the touch detection region R1, based on the touch detection signals RX received from the multiple common electrodes 34 in the touch detection region R1. During the touch detection period T2a, the touch detection circuit 76 performs detection of a touch by an object on the touch detection region R2, based on the touch detection signals RX received from the multiple common electrodes 34 in the touch detection region R2.

During the touch detection period T3a, the touch detection circuit 76 performs detection of a touch by an object on the touch detection region R3, based on the touch detection signals RX received from the multiple common electrodes 34 in the touch detection region R3. During the touch detection period T4a, the touch detection circuit 76 performs detection of a touch by an object on the touch detection region R4, based on the touch detection signals RX received from the multiple common electrodes 34 in the touch detection region R4.

Thus, during each of the multiple touch detection periods, the touch detection circuit 76 performs touch detection in a touch detection region different for each touch detection period. The display device 22 may include touch detection regions equal in number to the touch detection periods in a frame period Fa, and, in this case, the touch detection for one screen is performed once during the multiple touch detection periods in a frame period Fa.

In the first mode, when the touch detection circuit 76 receives exogenous noise besides the touch detection signals RX from common electrodes 34 during a touch detection period, the exogenous noise is likely to be transmitted from the touch detection circuit 76 to the first drive circuit 72, the second drive circuit 74, and the control circuit 70 within the control device 24. This is because the touch detection circuit 76, the first drive circuit 72, the second drive circuit 74, and the control circuit 70 are electrically connected to one another with signal wires or power supply wires, for example. When exogenous noise is transmitted to the first drive circuit 72 and the like, some influence, such as disturbance in the image, may be exerted depending on the strength of the exogenous noise. Accordingly, when image display needs to be preferentially performed, the mode is switched to the second mode.

### Second Mode

In the second mode, the display device 22 displays an image while the touch detection circuit 76 stops touch detection.

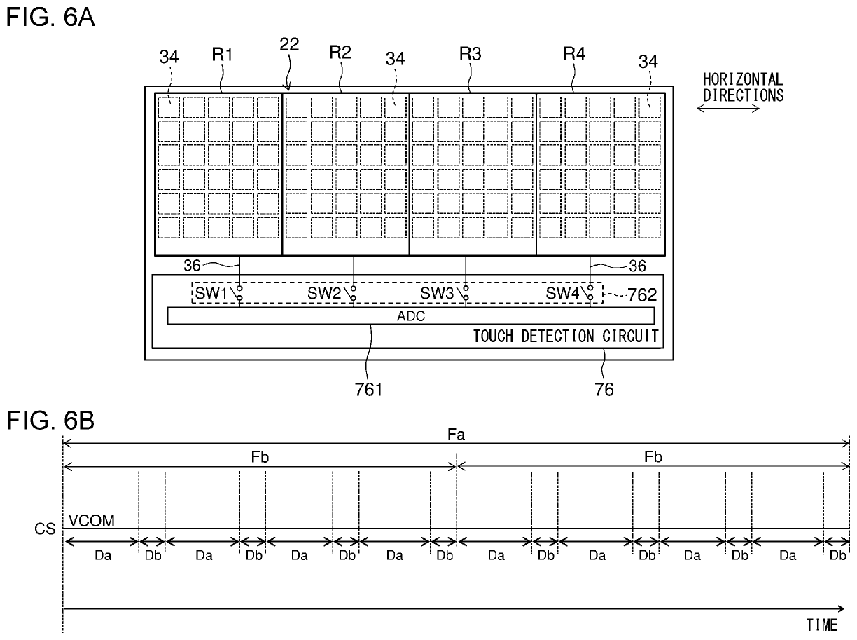

FIG. 6A is a diagram used to describe the operation of the display device 22 shown in FIG. 1 in the second mode. In the second mode, the control circuit 70 provides control to make the switches SW1-SW4 in the touch detection circuit 76 non-conductive, stops the operation of the A/D converter 761, and stops the touch detection by the touch detection circuit 76. Accordingly, the switch circuit 762 blocks supply of the signals from the multiple common electrodes 34 to the A/D converter 761. Since the switches SW1-SW4 are made non-conductive, the signal input paths from the multiple common electrodes 34 to the control device 24 are electrically disconnected.

FIG. 6B shows timings and a waveform of the common electrode signal CS within a frame period Fa in the second mode of the display device 22 shown in FIG. 1. In the second mode, the control circuit 70 provides control such that, within a frame period Fa, the display periods Da and display stop periods Db, for which the display device 22 stops image display, are alternately arranged. The length, start timing, and end timing of each display period Da are identical with those in the first mode. Also, the length, start timing, and end timing of each display stop period Db are identical with the length, start timing, and end timing of a touch detection period in the first mode.

In the second mode, the operation of the first drive circuit 72 is the same as that in the first mode. Also, in the second mode, the second drive circuit 74 supplies the reference voltage VCOM to each of the multiple common electrodes 34 during each display period Da and each display stop period Db. In other words, as shown in FIG. 6B, the second drive circuit 74 continuously supplies the reference voltage VCOM in the second mode.

In the second mode, since the touch detection circuit 76 stops touch detection, exogenous noise received at the common electrodes 34 is less likely to be input to the touch detection circuit 76. Since the switches SW1-SW4 are made non-conductive, exogenous noise becomes less likely to be input to the touch detection circuit 76 more certainly. Accordingly, the exogenous noise is less likely to be transmitted from the touch detection circuit 76 to the first drive circuit 72 and the like. This can restrain exertion of influence by exogenous noise on image display, without adding an electrode for shielding in the display device 22. Therefore, without degradation of accuracy and sensitivity of touch position detection in the first mode, images can be made less affected by exogenous noise in the second mode.

For example, while a camera display function is performed, the display device 22 functions as a back monitor used to check if there is an obstacle when the vehicle backs up, so that the image desirably includes less disturbance. In the second mode, since disturbance in the image is less likely to occur even when exogenous noise exists, the image of an area in the rear of the vehicle can be checked more easily.

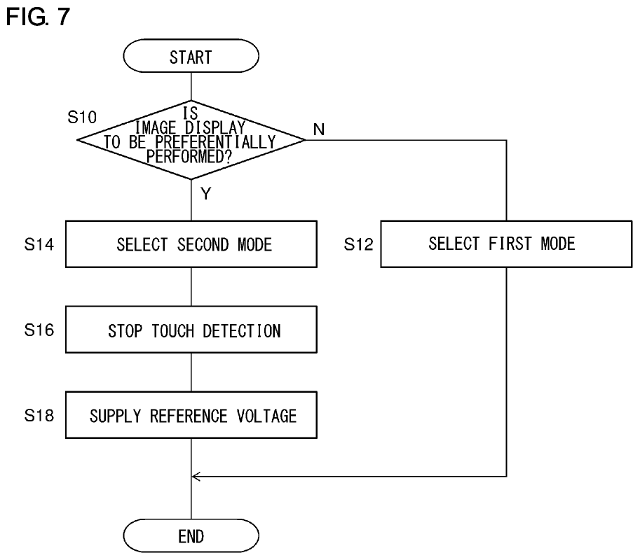

There will now be described the overall operation of the display system 1 having the configuration set forth above. FIG. 7 is a flowchart that shows mode selection processing performed in the display system 1 shown in FIG. 1. The processing shown in FIG. 7 is performed regularly at a predetermined frequency. When image display need not be preferentially performed (N at S10), the selector 90 selects the first mode (S12), and the processing is terminated. When image display is to be preferentially performed (Y at S10), the selector 90 selects the second mode (S14). Accordingly, the touch detection circuit 76 stops touch detection (S16), the second drive circuit 74 continuously supplies the reference voltage VCOM (S18), and the processing is terminated.

According to the present embodiment, when image display needs to be preferentially performed, the image can be made less affected by exogenous noise. Also, in the second mode, the control of the first drive circuit 72 need not be changed from that in the first mode, and what should be done is to stop the touch detection and continuously supply the reference voltage VCOM. In other words, also in the second mode, the control of image display in a time division manner in the first mode need not be changed. This can prevent complication of the control in the second mode.

### Second Embodiment

The second embodiment differs from the first embodiment in that the second mode is selected when exogenous noise is detected. In the following, description will be given mainly for the differences from the first embodiment.

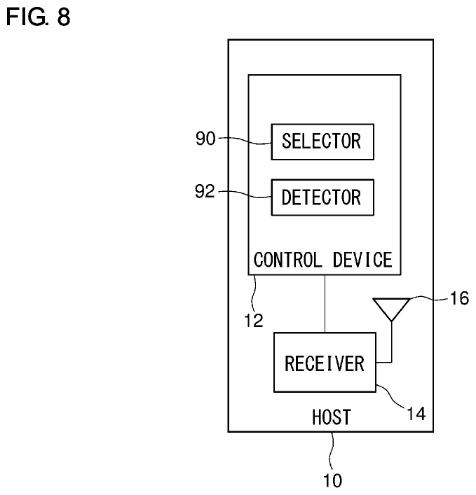

FIG. 8 is a block diagram of the host 10 according to the second embodiment. The control device 12 includes the selector 90 and a detector 92. The detector 92 detects exogenous noise received at the touch detection circuit 76 via the common electrodes 34, and exogenous noise received at the receiver 14 via the antenna 16. The common electrodes 34 correspond to antennas, so that this processing corresponds to that the detector 92 detects exogenous noise received via antennas. The detector 92 may detect one of the exogenous noise received at the touch detection circuit 76 and the exogenous noise received at the receiver 14.

The receiver 14 acquires strength of a signal received at the antenna 16 and outputs the strength thus acquired to the detector 92. When the strength output from the receiver 14 is greater than or equal to a first threshold determined in advance, the detector 92 judges that exogenous noise has been detected. When the strength is smaller than the first threshold, the detector 92 judges that exogenous noise has not been detected. The noise detection may be performed using well-known technologies.

Also, during a touch detection period in the first mode, when the touch detection circuit 76 receives, besides the touch detection signals RX, exogenous noise having strength at a predetermined level or higher from the common electrodes 34, an output signal as a digital value from the A/D converter 761 can be an abnormal value. The A/D converter 761 outputs an output signal to the control circuit 70, which then outputs the output signal from the A/D converter 761 to the detector 92. When the output signal from the A/D converter 761 is greater than or equal to a second threshold determined in advance, the detector 92 judges that exogenous noise has been detected. When the output signal from the A/D converter 761 is smaller than the second threshold, the detector 92 judges that exogenous noise has not been detected. The detector 92 outputs the detection result to the selector 90.

The first threshold and the second threshold may be appropriately determined through experiments and simulations such as to detect exogenous noise having strength that may affect the image display.

When the detector 92 has not detected exogenous noise, the selector 90 selects the first mode. When the detector 92 has detected exogenous noise, the selector 90 selects the second mode. Accordingly, even in a situation with exogenous noise having strength that may affect the image display, the image can be made less affected by the exogenous noise.

After the detector 92 has detected exogenous noise and the selector 90 has selected the second mode, when a predetermined return condition is satisfied, the selector 90 selects the first mode. More specifically, the selector 90 selects the first mode at the time when the exogenous noise is no longer detected after the detector 92 has detected exogenous noise based on a signal received at the receiver 14. Accordingly, when exogenous noise decreases, the mode is returned to the first mode, and the touch detection can be resumed.

Meanwhile, the selector 90 selects the first mode at the time when a predetermined waiting period has elapsed after the detector 92 has detected exogenous noise based on a signal received at the touch detection circuit 76. The waiting period may be appropriately determined through experiments and simulations. After the waiting period has elapsed and the first mode is selected, if the detector 92 detects exogenous noise again, the selector 90 will select the second mode again; if the detector 92 does not detect exogenous noise, on the other hand, the first mode will be maintained. Accordingly, when the exogenous noise decreases, the touch detection can be resumed.

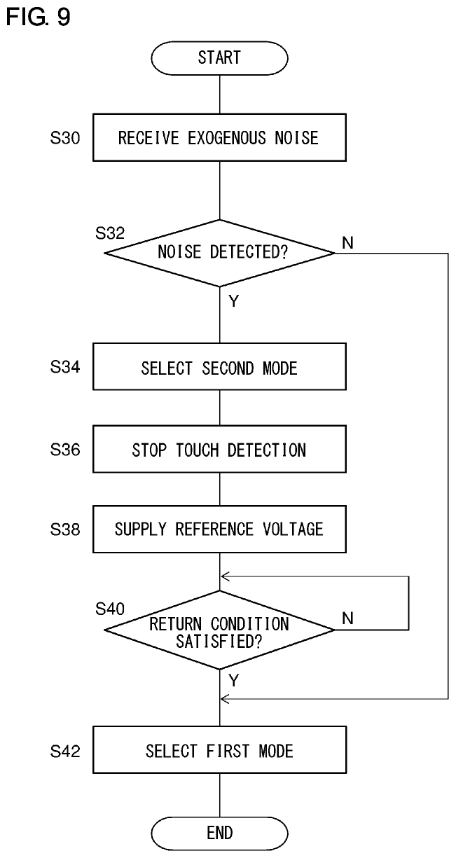

FIG. 9 is a flowchart that shows mode selection processing performed in the display system 1 according to the second embodiment. The processing shown in FIG. 9 is performed regularly at a predetermined frequency. At least one of the touch detection circuit 76 or the receiver 14 receives exogenous noise (S30). When noise is no longer detected (N at S32), the selector 90 selects the first mode (S42), and the processing is terminated.

When noise is detected (Y at S32), the selector 90 selects the second mode (S34). Accordingly, the touch detection circuit 76 stops the touch detection (S36), and the second drive circuit 74 continuously supplies the reference voltage VCOM (S38). When the return condition is not satisfied (N at S40), the process returns to S40. When the return condition is satisfied (Y at S40), the selector 90 selects the first mode (S42), and the processing is terminated.

According to the present embodiment, the operation mode can be selected depending on whether or not there is exogenous noise that may affect the image display.

### Third Embodiment

The third embodiment differs from the first embodiment in that the display device 22 displays an image over a frame period Fa in the second mode. In the following, description will be given mainly for the differences from the first embodiment.

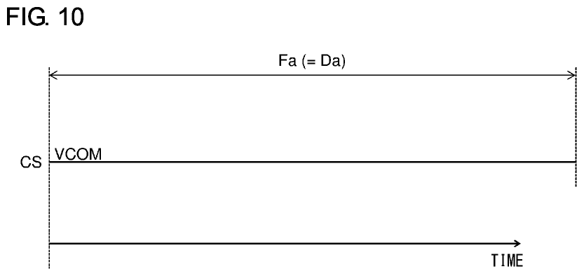

FIG. 10 shows a waveform of the common electrode signal CS within a frame period Fa in the second mode according to the third embodiment. In the second mode, the display device 22 displays an image over a frame period Fa. Accordingly, in the second mode, the control circuit 70 stops the control in a time division manner and makes a frame period Fa and a display period Da coincident with each other. Therefore, an image can be continuously displayed in the second mode.

The length of a frame period Fa in the first mode may be identical with that in the second mode. Also, a frame period Fa in the second mode may be shorter than a frame period Fa in the first mode. In this case, the length of a frame period Fa in the second mode may be identical with the sum of multiple display periods Da included in a frame period Fa in the first mode. Accordingly, since a frame period Fa is shorter in the second mode, the frame rate can be increased. Therefore, moving images can be displayed more smoothly in the second mode than in the first mode. Such smoother moving images are suitable when the display device 22 is used as a back monitor, for example.

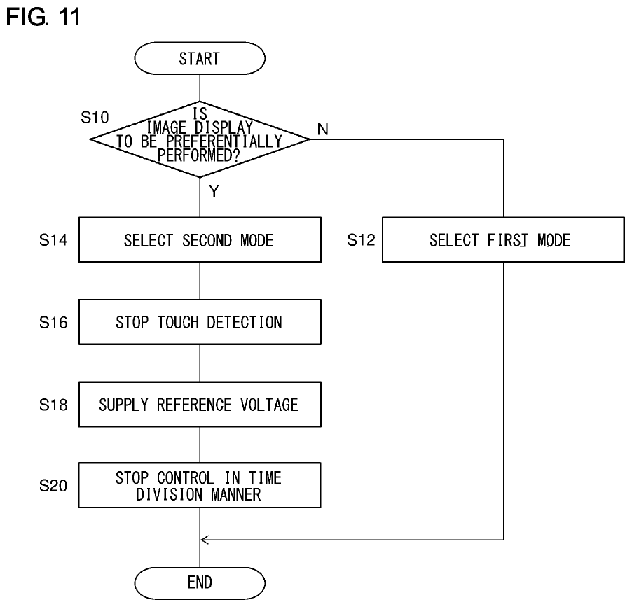

FIG. 11 is a flowchart that shows mode selection processing performed in the display system 1 according to the third embodiment. The processing shown in FIG. 11 is performed regularly at a predetermined frequency. The processes from S10 to S18 are the same as those in the first embodiment. After S18, the control circuit 70 stops the control in a time division manner (S20), and the processing is terminated.

### Fourth Embodiment

The fourth embodiment differs from the first embodiment in that a fixed voltage different from the reference voltage VCOM is supplied during each display stop period Db in the second mode. In the following, description will be given mainly for the differences from the first embodiment.

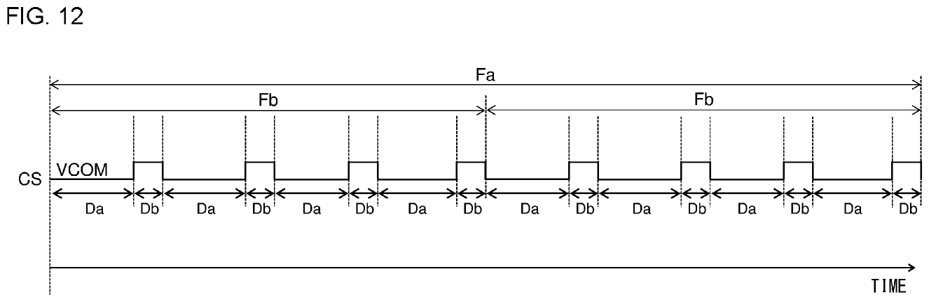

FIG. 12 shows timings and a waveform of the common electrode signal CS within a frame period Fa in the second mode according to the fourth embodiment. In the second mode, the second drive circuit 74 supplies the reference voltage VCOM during each display period Da and supplies a fixed voltage during each display stop period Db, to each of the multiple common electrodes 34. The fixed voltage may be an arbitrary voltage and may be the ground voltage.

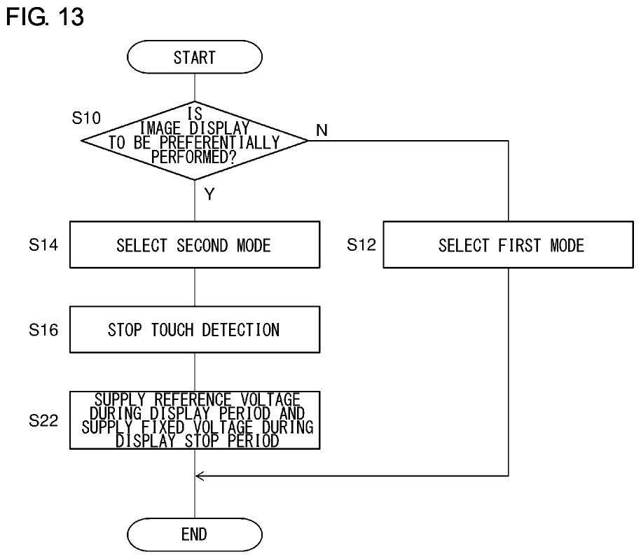

FIG. 13 is a flowchart that shows mode selection processing performed in the display system 1 according to the fourth embodiment. The processing shown in FIG. 13 is performed regularly at a predetermined frequency. The processes from S10 to S16 are the same as those in the first embodiment. After S16, the second drive circuit 74 supplies the reference voltage VCOM during each display period Da and supplies a fixed voltage during each display stop period Db (S22), and the processing is terminated.

The present embodiment allows greater flexibility in the configuration of the display system 1.

### Fifth Embodiment

The fifth embodiment differs from the first embodiment in that the touch drive signal TX is supplied during each display stop period Db in the second mode. In the following, description will be given mainly for the differences from the first embodiment.

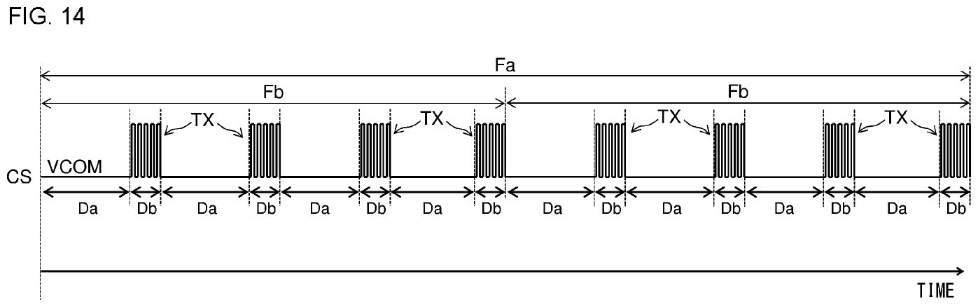

FIG. 14 shows timings and a waveform of the common electrode signal CS within a frame period Fa in the second mode according to the fifth embodiment. In the second mode, the second drive circuit 74 supplies the reference voltage VCOM during each display period Da and supplies the touch drive signal TX during each display stop period Db, to each of the multiple common electrodes 34. Since the display stop periods Db coincide with the touch detection periods, the second drive circuit 74 performs the same operation both in the first mode and the second mode.

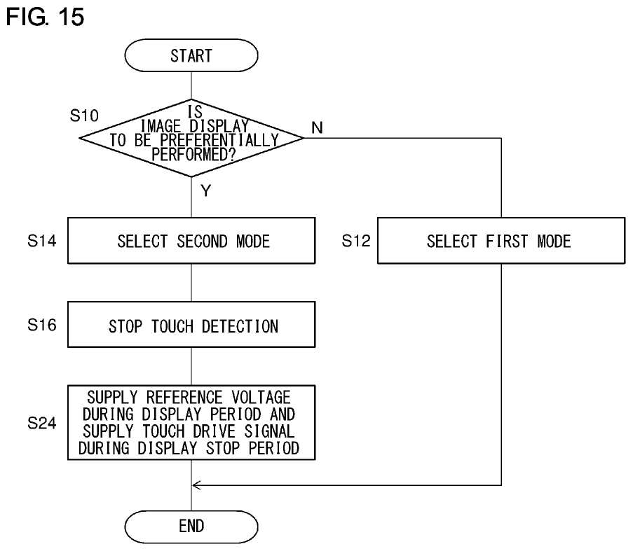

FIG. 15 is a flowchart that shows mode selection processing performed in the display system 1 according to the fifth embodiment. The processing shown in FIG. 15 is performed regularly at a predetermined frequency. The processes from S10 to S16 are the same as those in the first embodiment. After S16, the second drive circuit 74 supplies the reference voltage VCOM during each display period Da and supplies the touch drive signal TX during each display stop period Db (S24), and the processing is terminated.

According to the present embodiment, in the second mode, the control of the first drive circuit 72 and the second drive circuit 74 need not be changed from that in the first mode, and what should be done is to stop the touch detection by the touch detection circuit 76. Therefore, the control in the second mode can be simplified, compared to the first embodiment.

### Modification

In the second mode according to the first embodiment, during each of some frame periods among multiple successive frame periods, image display may be performed while touch detection is stopped, and, during each of the rest of the multiple successive frame periods, image display and touch detection may be performed in the same way as in the first mode.

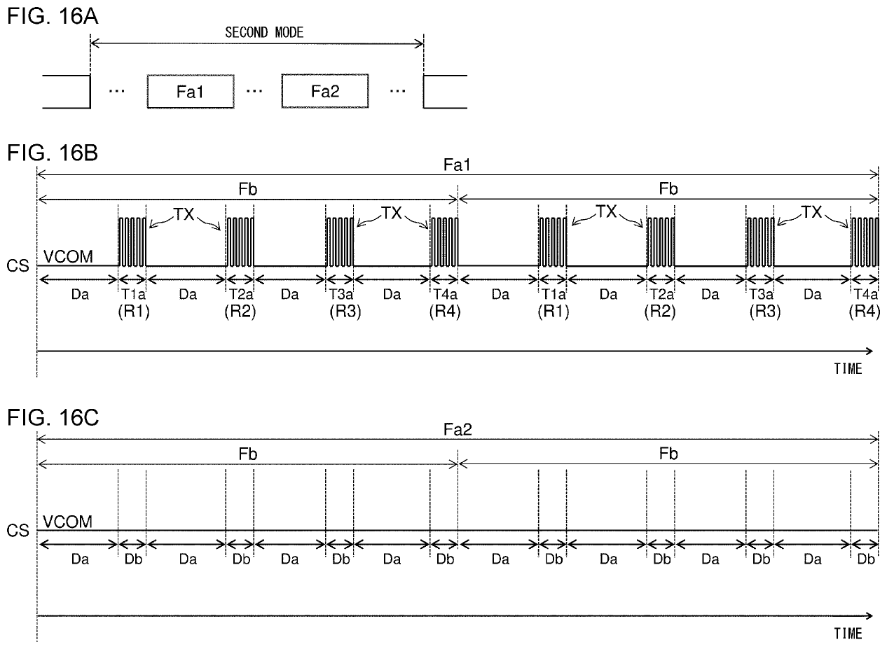

FIG. 16A illustrates multiple successive frame periods in the second mode according to a modification. The multiple successive frame periods include frame periods Fa1 and Fa2.

FIG. 16B shows a waveform of the common electrode signal CS within the frame period Fa1 in the second mode according to the modification. As with a frame period in the first mode, the frame period Fa1 is divided into two sub-frame periods Fb. Each sub-frame period Fb includes four display periods Da and four touch detection periods T1a, T2a, T3a, and T4a. Accordingly, during the frame period Fa1, image display and touch detection is performed in the same way as in the first mode. During the frame period Fa1, the operation of the first drive circuit 72, the second drive circuit 74, the control circuit 70, the switch circuit 762, and the touch detection circuit 76 is the same as that in the first mode. Accordingly, during the frame period Fa1, image display and touch detection is performed.

FIG. 16C shows a waveform of the common electrode signal CS within the frame period Fa2 in the second mode according to the modification. As with a frame period in the second mode according to the first embodiment, the frame period Fa2 includes the display periods Da and the display stop periods Db, for which the display device 22 stops image display, alternately arranged. During the frame period Fa2, the operation of the first drive circuit 72, the second drive circuit 74, the control circuit 70, the switch circuit 762, and the touch detection circuit 76 is the same as that in a frame period in the second mode according to the first embodiment. Accordingly, during the frame period Fa2, image display is performed, but touch detection is stopped.

In the second mode, some frame periods among multiple successive frame periods each include, as with the frame period Fa2, the display periods Da and the display stop periods Db, for which the display device 22 stops image display, alternately arranged; the rest of the multiple successive frame periods each include, as with the frame period Fa1, multiple display periods and multiple touch detection periods.

When the proportion of the frame periods Fa2, for which touch detection is stopped, to the multiple frame periods in the second mode is larger, images can be made less affected by exogenous noise. Accordingly, when image display is to be performed more preferentially, the proportion of the frame periods Fa2 for which touch detection is stopped may be increased. When image display is to be performed less preferentially, on the other hand, the proportion of the frame periods Fa2 for which touch detection is stopped may be decreased. Accordingly, images can be made less affected by exogenous noise, compared to the first mode, while the frequency of touch detection can be ensured.

In the present modification, the selector 90 may be set to select the second mode when the frequency of touch detection may be decreased. For example, a mode in which the frequency of touch detection may be decreased may be set in advance. Also, the selector 90 may select the second mode when a touch has not been detected for a predetermined period of time, for example. Also, based on a desired frequency of touch detection, the proportion of the frame periods Fa2, for which touch detection is stopped, to the multiple frame periods in the second mode may be set.

The present modification may be applied to the second embodiment. In the second embodiment, the second mode is selected when exogenous noise is detected. Accordingly, when the present modification is applied to the second embodiment, the proportion of the frame periods Fa2, for which touch detection is stopped, to the multiple frame periods in the second mode may suitably be larger.

The present modification may be applied to the third embodiment. Accordingly, in the second mode according to the third embodiment, touch detection may be stopped during each of some frame periods among multiple successive frame periods while the display device 22 displays an image over each of the some frame periods, and image display and touch detection may be performed in the same way as in the first mode during each of the rest of the multiple successive frame periods. More specifically, during a frame period Fa2 in the second mode according to the third embodiment, the control circuit 70 stops the control in a time division manner and makes the frame period Fa2 and a display period Da coincident with each other, as shown in FIG. 10.

The present modification may be applied to the fourth embodiment. Accordingly, in the second mode according to the fourth embodiment, during each of some frame periods among multiple successive frame periods, touch detection may be stopped and a fixed voltage different from the reference voltage VCOM may be supplied during each display stop period Db; during each of the rest of the multiple successive frame periods, image display and touch detection may be performed in the same way as in the first mode. More specifically, within a frame period Fa2 in the second mode according to the fourth embodiment, the second drive circuit 74 supplies the reference voltage VCOM during each display period Da and supplies a fixed voltage during each display stop period Db, to each of the multiple common electrodes 34, as shown in FIG. 12.

The present modification may be applied to the fifth embodiment. Accordingly, in the second mode according to the fifth embodiment, during each of some frame periods among multiple successive frame periods, touch detection may be stopped and the touch drive signal TX may be supplied during each display stop period Db; during each of the rest of the multiple successive frame periods, image display and touch detection may be performed in the same way as in the first mode. More specifically, within a frame period Fa2 in the second mode according to the fifth embodiment, the second drive circuit 74 supplies the reference voltage VCOM during each display period Da and supplies the touch drive signal TX during each display stop period Db, to each of the multiple common electrodes 34, as shown in FIG. 14.

The present modification may be applied to the fifth embodiment, and the second embodiment may be further combined therewith. Accordingly, the touch detection signals RX may be detected during a frame period Fa2 in the second mode, and, based on the touch detection signals RX thus detected, judgment of returning from the second mode to the first mode (FIG. 9, S40) may be performed, for example. More specifically, during a frame period Fa2 in the second mode, the control device 24 outputs the touch detection signals RX to the detector 92 in the same way as in the first mode. Based on the touch detection signals RX, the detector 92 detects exogenous noise. When the exogenous noise is no longer detected, the selector 90 selects the first mode.

The present disclosure has been described with reference to embodiments and a modification. The embodiments and modification are intended to be illustrative only, and it will be obvious to those skilled in the art that various modifications to a combination of constituting elements or processes therein could be developed and that such modifications also fall within the scope of the present disclosure.

For example, the control device 12 of the host 10 selects the operation mode in the embodiments. However, the process may be performed by the control circuit 70 of the display module 20, instead of the control device 12. In this case, the control circuit 70 includes the selector 90. Also, in the second embodiment, the control circuit 70 instead of the control device 12 may detect the exogenous noise. In this case, the control circuit 70 includes the detector 92. This modification allows greater flexibility in the configuration of the display system 1.

The second embodiment may be combined with the first embodiment. Also, one of the third, fourth, and fifth embodiments may be combined with the second embodiment or with the first and second embodiments. An additional embodiment made by such a combination has the effect of each of the combined embodiments.

Although the control device 24 is included in the display module 20 in the embodiments, the control device 24 may be included in the host 10. Also, although the first drive circuit 72 generates the reference clock signal in the embodiments, the second drive circuit 74 may generate the reference clock signal. Also, the number of touch detection periods included in a frame period may be more than three times the number of touch detection regions in the display device 22. These modifications allow greater flexibility in the configuration of the display system 1.

A display system according to one aspect of the present disclosure includes:

a display device including multiple gate lines, multiple source lines, multiple pixel electrodes provided respectively in regions defined by the multiple gate lines and the multiple source lines, and multiple common electrodes provided to face the multiple pixel electrodes and used for both image display and touch detection;

a drive circuit that supplies a reference voltage for image display during a display period, for which the display device displays an image, and supplies a touch drive signal during a touch detection period, to each of the multiple common electrodes;

a touch detection circuit that performs detection of a touch by an object on the display device, based on a touch detection signal received from each of the multiple common electrodes during the touch detection period; and

a selector that selects, as an operation mode of the display system, a first mode or a second mode,

the first mode is an operation mode in which the display period and the touch detection period are alternately arranged within each of multiple successive frame periods of the display device, and

the second mode is an operation mode in which, during at least one frame period, the display device displays an image while the touch detection circuit stops touch detection.

According to this aspect, since the touch detection circuit stops touch detection in the second mode, exogenous noise received at the common electrodes is less likely to be transmitted from the touch detection circuit to the drive circuit. Therefore, images can be made less affected by exogenous noise.

In the display system according to the one aspect of the present disclosure, for example,

when image display is to be preferentially performed, the selector may select the second mode.

In this case, when image display needs to be preferentially performed, the image can be made less affected by exogenous noise.

The display system according to the one aspect of the present disclosure may further include a detector that detects noise received at an antenna, for example, and,

when the detector has detected noise, the selector may select the second mode.

In this case, when exogenous noise exists, the image can be made less affected by the exogenous noise.

The display system according to the one aspect of the present disclosure may further include a receiver that receives a wireless signal via the antenna, for example,

the detector may detect noise received at the receiver via the antenna, and,

the selector may select the first mode at the time when noise is no longer detected after the detector has detected noise.

In this case, when the exogenous noise decreases, the touch detection can be resumed.

In the display system according to the one aspect of the present disclosure, for example,

the antenna may include the multiple common electrodes,

the detector may detect noise received at the touch detection circuit via the multiple common electrodes, and,

the selector may select the first mode at the time when a predetermined waiting period has elapsed after the detector has detected noise.

In this case, when the exogenous noise decreases, the touch detection can be resumed.

In the display system according to the one aspect of the present disclosure, for example,

in the second mode, the display device may display an image over a frame period.

In this case, an image can be continuously displayed in the second mode.

In the display system according to the one aspect of the present disclosure, for example,

a frame period in the second mode may be shorter than a frame period in the first mode.

In this case, moving images can be displayed more smoothly in the second mode than in the first mode.

In the display system according to the one aspect of the present disclosure, for example,

in the second mode, the display period and a display stop period, for which the display device stops image display, may be alternately arranged within the at least one frame period.

In this case, in the second mode, the control in a time division manner need not be changed from that in the first mode, and what should be done is to stop the touch detection. This can prevent complication of the control.

In the display system according to the one aspect of the present disclosure, for example,

within the at least one frame period in the second mode, the drive circuit may supply the reference voltage to each of the multiple common electrodes during the display period and the display stop period.

In this case, since the drive circuit continuously supplies the reference voltage in the second mode, complication of the control can be prevented.

In the display system according to the one aspect of the present disclosure, for example,

within the at least one frame period in the second mode, the drive circuit may supply the reference voltage during the display period and may supply a fixed voltage different from the reference voltage during the display stop period, to each of the multiple common electrodes.

This allows greater flexibility in the configuration of the display system.

In the display system according to the one aspect of the present disclosure, for example, within the at least one frame period in the second mode, the drive circuit may supply the reference voltage during the display period and may supply the touch drive signal during the display stop period, to each of the multiple common electrodes.

In this case, in the second mode, the control in a time division manner and the control of the drive circuit need not be changed from that in the first mode, and what should be done is to stop the touch detection by the touch detection circuit. This can prevent complication of the control.

In the display system according to the one aspect of the present disclosure, for example, the touch detection circuit may include:

a processing circuit that processes the touch detection signal; and

a switch circuit, connected between the multiple common electrodes and the processing circuit, that outputs, to the processing circuit, the touch detection signal supplied from a common electrode selected from among the multiple common electrodes in the first mode and that blocks supply of the touch detection signal from the multiple common electrodes to the processing circuit during the at least one frame period in the second mode, and

the touch detection circuit may perform touch detection based on the touch detection signal processed by the processing circuit.

In this case, exogenous noise received at the common electrodes is less likely to be input to the touch detection circuit in the second mode.

A control device according to one aspect of the present disclosure is provided in a display system that includes: a display device including multiple gate lines, multiple source lines, multiple pixel electrodes provided respectively in regions defined by the multiple gate lines and the multiple source lines, and multiple common electrodes provided to face the multiple pixel electrodes and used for both image display and touch detection; a drive circuit that supplies a reference voltage for image display during a display period, for which the display device displays an image, and supplies a touch drive signal during a touch detection period, to each of the multiple common electrodes; and a touch detection circuit that performs detection of a touch by an object on the display device, based on a touch detection signal received from each of the multiple common electrodes during the touch detection period, the control device includes

a selector that selects, as an operation mode of the display system, a first mode or a second mode,

the first mode is an operation mode in which the display period and the touch detection period are alternately arranged within each of multiple successive frame periods of the display device, and

the second mode is an operation mode in which, during at least one frame period, the display device displays an image while the touch detection circuit stops touch detection.

According to this aspect, images can be made less affected by exogenous noise.

A control method according to one aspect of the present disclosure is used in a display system that includes: a display device including multiple gate lines, multiple source lines, multiple pixel electrodes provided respectively in regions defined by the multiple gate lines and the multiple source lines, and multiple common electrodes provided to face the multiple pixel electrodes and used for both image display and touch detection; a drive circuit that supplies a reference voltage for image display during a display period, for which the display device displays an image, and supplies a touch drive signal during a touch detection period, to each of the multiple common electrodes; and a touch detection circuit that performs detection of a touch by an object on the display device, based on a touch detection signal received from each of the multiple common electrodes during the touch detection period, the control method includes

selecting, as an operation mode of the display system, a first mode or a second mode,

the first mode is an operation mode in which the display period and the touch detection period are alternately arranged within each of multiple successive frame periods of the display device, and

the second mode is an operation mode in which, during at least one frame period, the display device displays an image while the touch detection circuit stops touch detection.

According to this aspect, images can be made less affected by exogenous noise.

While various embodiments have been described herein above, it is to be appreciated that various changes in form and detail may be made without departing from the spirit and scope of the invention(s) presently or hereafter claimed.

### CROSS-REFERENCE TO RELATED APPLICATIONS

This application is a Continuation of International Application No. PCT/JP2020/015646, filed on Apr. 7, 2020, which in turn claims the benefit of Japanese Application No. 2019-074904, filed on Apr. 10, 2019, the disclosures of which Applications are incorporated by reference herein.

1. A display system, comprising:
a display device comprising a plurality of gate lines, a plurality of source lines, a plurality of pixel electrodes provided respectively in regions defined by the plurality of gate lines and the plurality of source lines, and a plurality of common electrodes provided to face the plurality of pixel electrodes and used for both image display and touch detection;
a drive circuit that supplies a reference voltage for image display during a display period, for which the display device displays an image, and supplies a touch drive signal during a touch detection period, to each of the plurality of common electrodes;
a touch detection circuit that performs detection of a touch by an object on the display device, based on a touch detection signal received from each of the plurality of common electrodes during the touch detection period; and
a CPU that selects, as an operation mode of the display system, a first mode or a second mode, wherein
the first mode is an operation mode in which the display period and the touch detection period are alternately arranged within each of a plurality of successive frame periods of the display device, and
the second mode is an operation mode in which, during at least one frame period, the display device displays an image while the touch detection circuit stops touch detection.

2. The display system according to claim 1, wherein, when image display is to be preferentially performed, the CPU selects the second mode.

3. The display system according to claim 1, wherein
the CPU detects noise received at an antenna, and
when the CPU has detected noise, the CPU selects the second mode.

4. The display system according to claim 3, further comprising a receiver that receives a wireless signal via the antenna, wherein
the CPU detects noise received at the receiver via the antenna, and,
the CPU selects the first mode at the time when noise is no longer detected after the CPU has detected noise.

5. The display system according to claim 3, wherein
the antenna includes the plurality of common electrodes,
the CPU detects noise received at the touch detection circuit via the plurality of common electrodes, and,
the CPU selects the first mode at the time when a predetermined waiting period has elapsed after the CPU has detected noise.

6. The display system according to claim 1, wherein, in the second mode, the display device displays an image over a frame period.

7. The display system according to claim 6, wherein a frame period in the second mode is shorter than a frame period in the first mode.

8. The display system according to claim 1, wherein, in the second mode, the display period and a display stop period, for which the display device stops image display, are alternately arranged within the at least one frame period.

9. The display system according to claim 8, wherein, within the at least one frame period in the second mode, the drive circuit supplies the reference voltage to each of the plurality of common electrodes during the display period and the display stop period.

10. The display system according to claim 8, wherein, within the at least one frame period in the second mode, the drive circuit supplies the reference voltage during the display period and supplies a fixed voltage different from the reference voltage during the display stop period, to each of the plurality of common electrodes.

11. The display system according to claim 8, wherein, within the at least one frame period in the second mode, the drive circuit supplies the reference voltage during the display period and supplies the touch drive signal during the display stop period, to each of the plurality of common electrodes.

12. The display system according to claim 1, wherein the touch detection circuit comprises:
a processing circuit that processes the touch detection signal; and
a switch circuit, connected between the plurality of common electrodes and the processing circuit, that outputs, to the processing circuit, the touch detection signal supplied from a common electrode selected from among the plurality of common electrodes in the first mode and that blocks supply of a signal from the plurality of common electrodes to the processing circuit during the at least one frame period in the second mode, wherein
the touch detection circuit performs touch detection based on the touch detection signal processed by the processing circuit.

13. A control device provided in a display system, the display system comprising: a display device comprising a plurality of gate lines, a plurality of source lines, a plurality of pixel electrodes provided respectively in regions defined by the plurality of gate lines and the plurality of source lines, and a plurality of common electrodes provided to face the plurality of pixel electrodes and used for both image display and touch detection; a drive circuit that supplies a reference voltage for image display during a display period, for which the display device displays an image, and supplies a touch drive signal during a touch detection period, to each of the plurality of common electrodes; and a touch detection circuit that performs detection of a touch by an object on the display device, based on a touch detection signal received from each of the plurality of common electrodes during the touch detection period, the control device comprising
a CPU that selects, as an operation mode of the display system, a first mode or a second mode, wherein
the first mode is an operation mode in which the display period and the touch detection period are alternately arranged within each of a plurality of successive frame periods of the display device, and
the second mode is an operation mode in which, during at least one frame period, the display device displays an image while the touch detection circuit stops touch detection.

14. A control method used in a display system, the display system comprising: a display device comprising a plurality of gate lines, a plurality of source lines, a plurality of pixel electrodes provided respectively in regions defined by the plurality of gate lines and the plurality of source lines, and a plurality of common electrodes provided to face the plurality of pixel electrodes and used for both image display and touch detection; a drive circuit that supplies a reference voltage for image display during a display period, for which the display device displays an image, and supplies a touch drive signal during a touch detection period, to each of the plurality of common electrodes; and a touch detection circuit that performs detection of a touch by an object on the display device, based on a touch detection signal received from each of the plurality of common electrodes during the touch detection period, the control method comprising
selecting, as an operation mode of the display system, a first mode or a second mode, wherein
the first mode is an operation mode in which the display period and the touch detection period are alternately arranged within each of a plurality of successive frame periods of the display device, and
the second mode is an operation mode in which, during at least one frame period, the display device displays an image while the touch detection circuit stops touch detection.
